(19) United States
(12) Patent Application Publication
(10) Pub. No.: US 2026/0253140 A1
(43) Pub. Date: Aug. 27, 2026

(54) Systems and Methods for Calculating and Converting Units of Reits

(71) Applicant: Legendary Capital, LLC, Fargo, ND (US)

(72) Inventor: Corey Maple, Fargo, ND (US)

(21) Appl. No.: 19/244,218

(22) Filed: Jun. 20, 2025

Related U.S. Application Data
(63) Continuation-in-part of application No. 19/059,597, filed on Feb. 21, 2025.

(51) Int. Cl. G06Q 40/06; G06Q 50/16

(52) U.S. Cl. CPC G06Q 40/06; G06Q 50/16

(57) ABSTRACT

Systems and methods are provided for determining the value of real estate contributed to an umbrella partnership real estate investment trust (UPREIT). A computer-implemented process includes accepting title to contributed real estate, issuing transition units based on historical performance metrics, and later converting those units to common units based on actual property performance. Valuation adjustments may account for capital expenditures, debt, minimum yield requirements, and other operating costs. Contributors are incentivized through deferred but performance-based compensation, while the UPREIT is protected from premature overvaluation. The system ensures accurate, equitable valuation of real estate contributions through dynamic revaluation and conversion mechanisms.

### CROSS REFERENCE TO RELATED APPLICATION[S]

This application claims priority as a continuation-in-part of U.S. Nonprovisional patent application Ser. No. 19/059,597 (01CON01-02262-LEG) filed Feb. 21, 2025, which is a continuation of U.S. Nonprovisional patent application Ser. No. 17/410,534 (02259-LEG) filed Aug. 24, 2021, which claims priority to U.S. Provisional Patent Application No. 63/069,429 filed Aug. 24, 2020, which are herein incorporated by reference in their entirety.

### BACKGROUND

The present disclosure relates to a method for determining a value of real estate contributed to an umbrella partnership REIT (UPREIT).

A real estate investment trust (REIT) is a type of corporation that invests in real estate and that is subject to its own set of rules in the United States' tax code. REITs can acquire real estate in different ways. As examples, REITs can acquire real estate through a direct purchase for cash or through a contribution of the real estate in exchange for shares of the REIT. For another example, REITs can acquire real estate through what is referred to as an umbrella partnership REIT (UPREIT).

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A computer implemented method for determining a value of real estate contributed to an umbrella partnership REIT (UPREIT) according to one disclosed non-limiting embodiment of the present disclosure includes using a computer system to: accept ownership of the contributed real estate through the UPREIT's operating partnership; determine and distribute transition units based only on the property's historical net operating income (NOI); calculate a revised value for those units based on actual NOI and applicable expenses; and convert the transition units to common units once the property has stabilized and reached a target NOI.

A further embodiment of any of the foregoing embodiments of the present disclosure includes the number of transition units being calculated using a capitalization rate.

A further embodiment of any of the foregoing embodiments of the present disclosure includes the system revaluing the transition units after a set time to reflect the property's actual performance.

A further embodiment of any of the foregoing embodiments of the present disclosure includes the past year can being defined as a full calendar year, trailing 12 months, or the prior fiscal year.

A further embodiment of any of the foregoing embodiments of the present disclosure includes the number of transition units being based only on past performance, not future projections.

A further embodiment of any of the foregoing embodiments of the present disclosure includes distributing the transition units includes transferring ownership of them to the contributor.

A further embodiment of any of the foregoing embodiments of the present disclosure includes the value of the transition units being calculated 1 to 5 years after the real estate is contributed.

A further embodiment of any of the foregoing embodiments of the present disclosure includes the value of the transition units being calculated 6 to 10 years after the real estate is contributed.

A further embodiment of any of the foregoing embodiments of the present disclosure includes the transition unit value being reduced by costs the operating partnership incurred when taking ownership of the property.

A further embodiment of any of the foregoing embodiments of the present disclosure includes the transition unit value being reduced by costs related to assuming debt.

A further embodiment of any of the foregoing embodiments of the present disclosure includes the transition unit value being reduced by costs related to defeasing debt.

A further embodiment of any of the foregoing embodiments of the present disclosure includes the transition unit value being reduced by costs related to taking out new debt.

A further embodiment of any of the foregoing embodiments of the present disclosure includes the number of transition units being adjusted based on debt tied to the property that the operating partnership assumes.

A further embodiment of any of the foregoing embodiments of the present disclosure includes the number of transition units being adjusted based on debt tied to the property that the operating partnership defeases.

A further embodiment of any of the foregoing embodiments of the present disclosure includes the number of transition units being adjusted based on new debt the operating partnership takes out for the property.

A further embodiment of any of the foregoing embodiments of the present disclosure includes converting the common units of the operating partnership to common shares of the UPREIT when real estate is sold by operating partnership.

A further embodiment of any of the foregoing embodiments of the present disclosure includes converting the common units of the operating partnership to common shares of the UPREIT when liquidating the UPREIT's portfolio of property.

A further embodiment of any of the foregoing embodiments of the present disclosure includes a Contribution Agreement that sets the terms of the § 721 UPREIT deal, including distribution rates and NOI targets for the transition units.

A further embodiment of any of the foregoing embodiments of the present disclosure includes the converting occurring after 36 months.

A further embodiment of any of the foregoing embodiments of the present disclosure includes conversion that can be delayed by up to 12 months, but no distributions are made during that extension period.

A further embodiment of any of the foregoing embodiments of the present disclosure includes stabilization that is reached when average trash weight becomes consistent.

A further embodiment of any of the foregoing embodiments of the present disclosure includes stabilization that is reached when average water usage becomes consistent.

A further embodiment of any of the foregoing embodiments of the present disclosure includes stabilization that is reached when average sewage usage becomes consistent.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 schematically illustrates a schematic of an UPREIT, in accordance with certain embodiments of the present disclosure.

FIG. 2 schematically illustrates a block diagram of steps of a method for calculating values of transition units and converting the transition units to common shares, in accordance with certain embodiments of the present disclosure.

FIG. 3 schematically illustrates a block diagram of components of a system for carrying out the method of FIG. 2, in accordance with certain embodiments of the present disclosure.

FIG. 4 schematically illustrates a block diagram of steps of an equity preservation UPREIT Transaction and timeline method, in accordance with other embodiments of the present disclosure.

### DETAILED DESCRIPTION

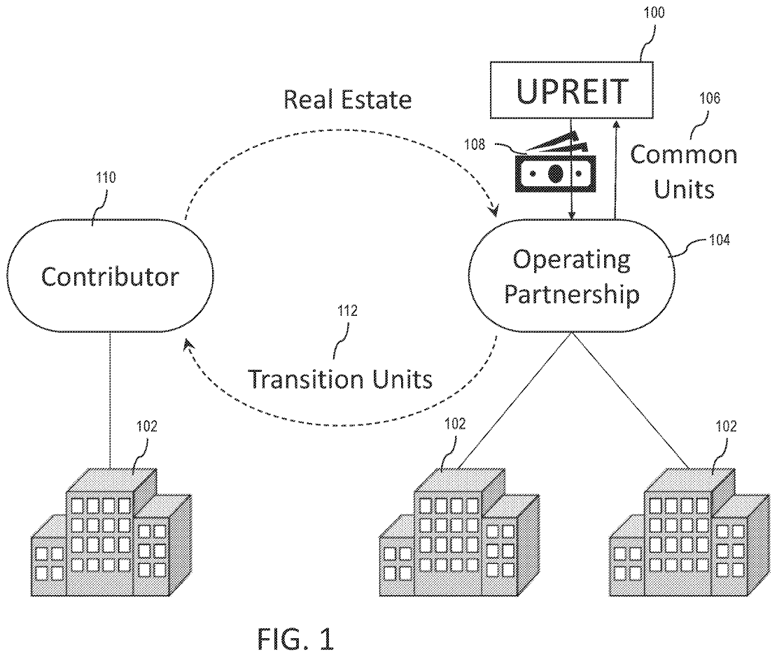

FIG. 1 illustrates a schematic of an UPREIT 100. With an UPREIT 100, instead of the REIT directly owning property once such property is acquired, the UPREIT's real estate 102 is indirectly owned through a partnership 104 of the UPREIT 100. The partnership 104 is typically referred to as an operating partnership, which operates subject to determined rules of the partnership.

The UPREIT 100 directly owns interest in the operating partnership 104 in the form of units 106. The UPREIT 100 can contribute capital 108 to the operating partnership 104 in exchange for the ownership units 106, and the capital 108 can be used to acquire and manage (e.g., operate, maintain, improve) the real estate 102 owned by the operating partnership 104. In certain embodiments, the real estate 102 owned by the operating partnership 104 is limited to a certain class or type of properties such as only hotels or only commercial office buildings. Of course, the real estate 102 can include different mixes of types of properties.

Those who contribute the real estate 102 to the UPREIT 100 can defer taxes on the contribution of the real estate 102. Based on the valuation of the contributed real estate, contributors 110 receive a certain number of the ownership units (e.g., transition units 112) of the operating partnership 104 in exchange for the contributed real estate 102. Under section 721 of the current tax code, such an exchange is not considered to be a taxable event.

One of the challenges of operating UPREITs 100 is determining the value of the real estate 102 at the time the real estate 102 is contributed. This is particularly challenging when the valuation occurs during an economic downturn or when the future income of a given parcel of real estate is otherwise uncertain. The contributor 110 may be over- or under-compensated in the form of units if a static valuation is determined at the time of the contribution, which would have either an overall accretive or dilutive effect on all unitholders. Regardless, there is a high probability of inappropriately valuing real estate 102 at that time. Moreover, if the contributed real estate 102 fails to meet the performance requirements assumed at the time of evaluation, the overall performance of the UPREIT 100 will be negatively affected. To address this performance risk, the UPREIT 100 may assume relatively low valuations on potential real estate. However, it may be difficult to find willing contributors 110 if the valuations are too low.

Certain embodiments of the present disclosure are accordingly directed to approaches for providing mutually-acceptable real estate valuations while providing improved performance of UPREITs.

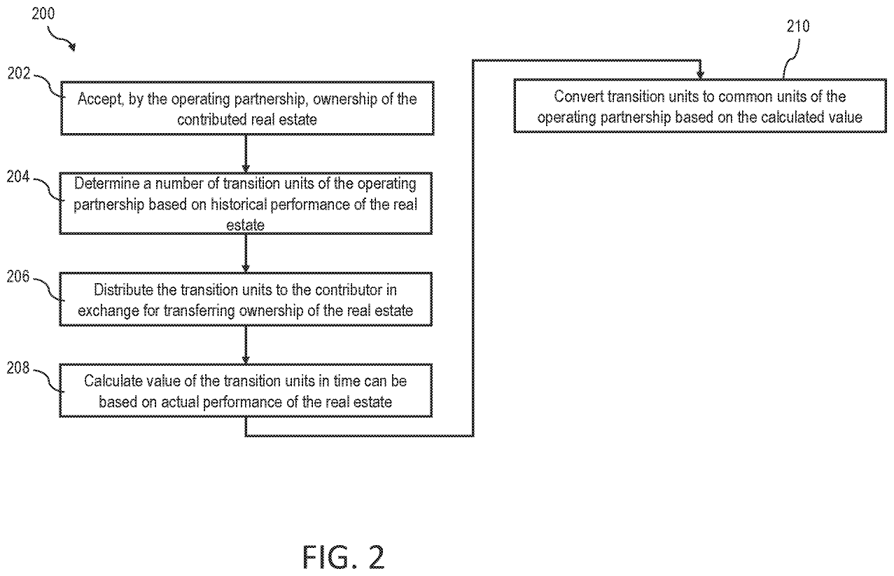

FIG. 2 outlines various steps of a method 200 for calculating values of transition units and converting the transition units to common units of the operating partnership 104 which ultimately can be converted to common shares of the UPREIT 100. The various steps of the method 200 described below can be carried out in different orders and can be carried out in parallel and/or serially.

The method 200 includes accepting, by the operating partnership 104, ownership of the contributed real estate 102 (block 202 in FIG. 2). This may include accepting the title to the real estate as evidenced by a legal instrument such as a deed. The deed can be recorded at the appropriate municipality.

The method 200 further includes determining a number of transition units 112 of the operating partnership 104 based on historical performance of the real estate 102 (block 204 in FIG. 2). In certain embodiments, the historical performance is or includes the prior year's financial performance. For example, if the real estate 102 is being evaluated in March 2020, the prior year's financial performance can include the performance over the past 12 months (e.g., trailing 12 months from March 2019 to February 2020), the past full calendar year (e.g., January 2019 to December 2019), or the past full fiscal year of the entity contributing the real estate 102. As another example, the historical performance can include 1-, 3-, or 5-year proformas for the real estate 102. As another example, the historical performance can include an appraisal. In certain embodiments, the historical performance is limited only to the past year's performance and not to earlier years.

The financial performance can be determined based, at least in part, on a desired capitalization rate of the real estate 102. The capitalization rate is the ratio of the net operating income of the real estate 102 to the asset value of the real estate. For example, if a given piece of real estate sold for $5,000,000 and had a net operating income of $500,000, then the capitalization rate would be 10% (i.e., $500,000 divided by $5,000,000). In determining the value of the real estate 102 to be contributed to the UPREIT 100, the operating partnership 104 can set a desired capitalization rate (e.g., 10%, 11%, 12%). That set capitalization rate and the past year's net operating income of the real estate 102 can then be used to determine the value of the real estate 102. The applied capitalization rate can be set at different rates for different contributors 110. For example, the capitalization rate for one contributor 110 can be set of 10% while the capitalization rate for a different contributor 110 can be set higher at 11.5%.

In certain embodiments, the number of transition units 112 for a given piece of real estate can be determined without being based on any future or projected performance of the real estate 102. Using only historical performance (e.g., the past year's performance, proformas, appraisals) in determining the number of transition units 112—particularly during an economic downturn—is counterintuitive. However, using historical performance establishes a valuation that is likely to be acceptable to those who are contributing the real estate 102. As described further below, the valuation of the transition units 112 can change after the initial valuation, which is made at the time the real estate is contributed to the operating partnership 104.

In certain embodiments, when the real estate 102 is contributed, the operating partnership assumes or defeases debt or takes out new debt associated with the contributed real estate 102. The assumption, defeasance, or new debt issuance can occur contemporaneously with contribution of the real estate 102. In such embodiments, the number of transition units 112 for a given piece of real estate is reduced by the amount of the debt.

Once the number of transition units 112 is determined, those transition units 112 can be distributed to the contributor 110 in exchange for transferring ownership of the real estate 102 (block 206 in FIG. 2). As such, immediately after the exchange or transaction, the contributor 110 owns the transition units 112 and the operating partnership 104 owns the contributed real estate 102. This exchange or transaction occurs without money or cash being transferred between the parties. However, in certain embodiments, a limited amount of money or cash may be transferred from the operating partnership 104 to the contributor 110 at the time of exchange or transaction.

After the exchange, the operating partnership 104 is responsible for managing the contributed property. For example, the operating partnership 104 is responsible for paying for maintenance, operating expenses, improvements, and the like of the real estate 102. In certain embodiments, the operating partnership 104 and the contributor 110 mutually select a management company as part of the transaction. [0022] The transition units 112 transferred to a given contributor 110 can be associated with rules or requirements (e.g., as provided under a contract) that are unique to the specific real estate 102 contributed by the contributor 110. For example, under terms of a contract, the transition units 112 can be given or associated with characteristics that are based on the actual financial performance of the contributed real estate 102. The characteristics of the transition units 112 may vary in concert with varying financial performance of the contributed real estate 102. Put another way, the characteristics of the transition units 112 can track the actual performance of the real estate 102. For example, given transition units 112 may receive distributions or dividends based on the actual performance of the associated real estate 102. As another example, given transition units 112 may receive varying levels of income or loss allocation from the operating partnership 104. As another example, given transition units 112 may receive varying hold period before the contributor 110 is able to transition, convert, or transfer such units.

In certain embodiments, the value of the transition units 112 is determined or revaluated after a set period of time. For example, the transition units 112 can be reevaluated 1-5 years (e.g., 2 years, 3 years) after the transition units 112 were distributed to a given contributor 110. The specific period of time between the initial valuation and the revaluation can be dictated by a contract between the operating partnership 104 and the contributor 110.

The value of the transition units 112 at the later point in time can be based on the past year's financial performance (block 208 in FIG. 2), and the financial performance can be measured using the same approach used for determining the initial value of the contributed real estate 102. For example, the past year's net operating income and the set capitalization rate can be used for the initial valuation and subsequent valuation. If the net operating income at the time of the revaluation is less than the net operating income at the time of contribution, the value of the transition units 112 can be reduced by a corresponding amount. For example, if the net operating income has been reduced by 10% at the time of revaluation, the current value of the transition units 112 can likewise be reduced by 10%. As another example, if the net operating income is the same at revaluation, the current value of the transition units 112 would be the same as the value when the real estate 102 was contributed.

In certain embodiments, the value of the transition units 112 at revaluation can be reduced by offsets. For example, the value of the transition units 112 at revaluation can be reduced by amounts incurred or accrued by the operating partnership 104 in closing the real estate 102, operating the real estate 102, or improving the real estate 102, through, as an example, a property improvement plan or capital expenditures. As another example, the value of the transition units 112 at revaluation can be reduced by the amount of the assumed debt or originated debt. As another example, the value of the transition units 112 at revaluation can be reduced by amounts incurred or accrued by the operating partnership 104 to assume outstanding debt, defease outstanding debt, or originate new debt. As another example, the value of the transition units 112 at revaluation can be reduced by a stated minimum yield on the operating partnership's or the UPREIT's invested capital. In one embodiment, the value of the transition units 112 at revaluation is reduced by all of the above-noted amounts.

This revaluation can occur before the transition units 112 are converted to common units 106 of the operating partnership 104. As such, the investors who own the common units 106 limit the risk that the common units are diluted or underperform when the transition units 112 are ultimately converted to common units 106. However, the investors assume certain risk of maintaining or operating the property. In certain embodiments, before the transition units 112 are converted to common units 106, certain expenses and costs are subtracted from the calculated value of the contributed real estate 102.

Once the ultimate value of the contributed real estate 102 is calculated, the transition units 112 can be converted to common units 106 of the operating partnership 104 based on the calculated value (block 210 in FIG. 2). After the conversion, the contributors 110 have the same rights under the operating partnership 104 as other holders of the common units 106.

In certain embodiments, the common units 106 of the operating partnership 104 are converted into common shares of the UPREIT 100. For example, in the event the UPREIT 100 liquidates, the common units 106 can be converted to common shares. When such a conversion occurs, the contributor(s) 110 can participate in returns and/or capital gains resulting from the sale either of the contributed real estate 102 or from the sale of the entire portfolio of real estate 102 of the UPREIT 100.

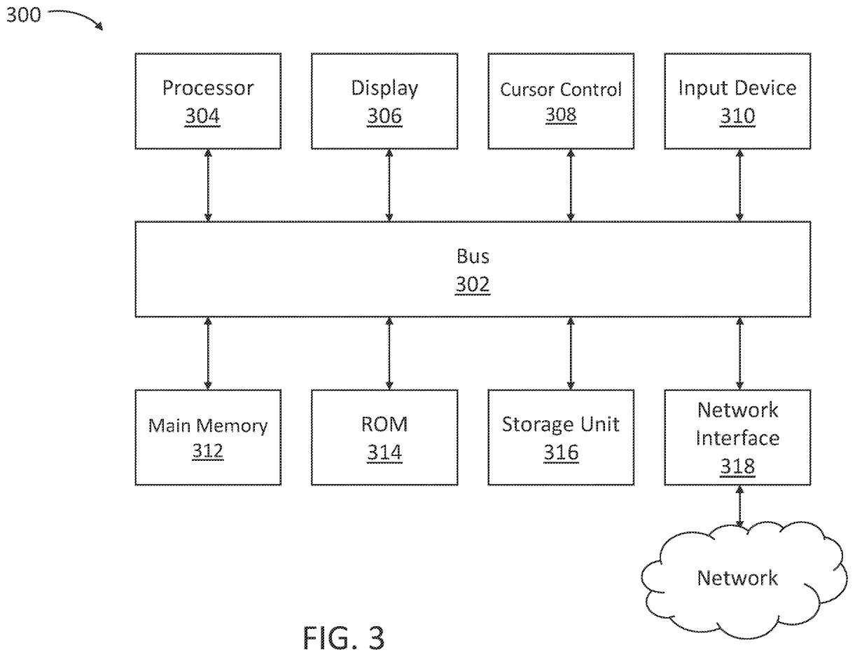

FIG. 3 schematically illustrates a block diagram of illustrative components of a computer system 300 for carrying out aspects of the method 200 described above. For example, in some embodiments, prior to the processes (e.g., steps) of the method 200 being performed, additional processes occur which may be performed by the computing system 300. For example, additional processes including but not limited to underwriting of the real estate 102 occur before the processes of method 200. Such initial underwriting may be performed using a computing system 300. This diagram is merely an example, which should not unduly limit the scope of the claims.

The computing system 300 includes a bus 302 or other communication mechanism for communicating information between or among a processor 304, a display 306, a cursor control component 308, an input device 310, a main memory 312, a read only memory (ROM) 314, a storage unit 316, and/or a network interface 318. In some examples, the bus 302 is coupled to the processor 304, the display 306, the cursor control component 308, the input device 310, the main memory 312, the ROM 314, the storage unit 316, and/or the network interface 318. And, in certain examples, the network interface 318 is coupled to a network 320.

In some examples, the processor 304 includes one or more general purpose microprocessors. In some examples, the main memory 312 (e.g., random access memory (RAM), cache and/or other dynamic storage devices) is configured to store information and instructions to be executed by the processor 304. In certain examples, the main memory 312 is configured to store temporary variables or other intermediate information during execution of instructions to be executed by processor 304. For example, the instructions, when stored in the storage unit 316 accessible to processor 304, render the computing system 300 into a special-purpose machine that is customized to perform the operations specified in the instructions (e.g., the method 200). In some examples, the ROM 314 is configured to store static information and instructions for the processor 304. In certain examples, the storage unit 316 (e.g., a magnetic disk, optical disk, or flash drive) is configured to store information and instructions.

In some embodiments, the display 306 (e.g., an LCD display or a touch screen) is configured to display information to a user of the computing system 300. In some examples, the input device 310 (e.g., alphanumeric and other keys) is configured to communicate information and commands to the processor 304. For example, the cursor control 308 (e.g., a mouse, a trackball, or cursor direction keys) is configured to communicate additional information and commands (e.g., to control cursor movements on the display 306) to the processor 304.

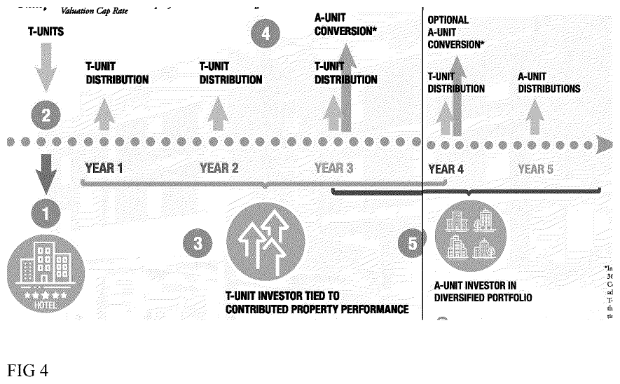

With reference to FIG. 4, an equity preservation UPREIT Transaction and timeline method for an example property may include the following steps:
1. Property Contribution and Closing.

The contributing owner and LF-REIT III-OP enter into a Contribution Agreement (CA). The CA defines the § 721 UPREIT transaction's terms and conditions. Each Contribution Agreement contains its own negotiated terms which govern the contribution of property.
2. Unit Issuance.

LF-REIT III-OP issues T-Units to the Contributor. The Contributor is now a partner/investor in LF-REIT III-OP and will be tied to their property's performance until T-Units are converted to A-Units. The contribution agreement which allocates T-Units to a contributor will generally include distribution and conversion calculations that are impacted by the contributed property's specific net operating income (NOI). Thus, a contributor remains exposed to return risk based on the performance of their individual contributed property until such time as their T-Units are converted to A-Units. The number of T-Units issued is typically calculated based on targeted stabilized revenue and net operating income goals. These steps 1 and 2 may occur simultaneously as the property is deeded into LF-REIT III-OP similar to a standard sale, and the property is conveyed through a tide company process.
3. Distribution.

As the property re-stabilizes and approaches the stabilized NOI target, the contributor's T-Unit may begin receiving distributions. In examples, the NOI may stabilize after 2-3 years which can provide stabilized costs once, for example, average trash weight is consistent, water usage is consistent, sewage usage is consistent, etc. A property contributor's expectation during negotiations is going to be that the property's NOI will increase in future years relative to the trailing performance at the time of contribution. Due to this, the contributor has a risk that their compensation for the contribution would be less than the future expected NOI increases would justify, a position that can only be evaluated for accuracy in the future after contribution. That anticipated increase in NOI performance is the “stabilization” that is anticipated. These distributions are meant to reward the accurate prediction of NOI “stabilization” by the contributor, while protecting against downside risk for the operating partnership. The CA may define and stipulate the distribution rates and NOI targets associated with the issued T-Units. These distributions are contractually obligated if the NOI targets are met and are not dependent on the A-Unit distributions.
4. T-Unit to A-Unit Conversion.

In one example, T-Units generally convert to A-Units after 36 months. The number of A-Units is generally determined by finding the Base Conversion Value and subtracting items such as original debt, funds for recapitalization and capital expenditures, contributor liquidity and any applicable liquidity premium, all of which are dictated by the CA. The goal is to approximate the equity the Contributor would have realized through ownership and invested monetary and human capital. In certain circumstances, the Contributor may be given the option to convert later than 36 months after the contribution date. For example, depending on the circumstances, the Contributor may be given a 12-month extension (TME) option. A TME option allows for an additional year of re-stabilization at which time (48 months after the contribution date) the T-Units must be converted to A-Units under the procedure described above. The trade-off for the additional year is that no distributions' will be paid to the T-Units during the TME option time period.
5. Post-Conversion. After the conversion event the Contributor will own A-Units in LF-REIT III-OP and enjoy a diversified interest in LF-REIT III-OP's portfolio. This affords the contributor the same distribution rights afforded to LF-REIT III-OP's other A-Unit holders and the REIT's common shareholders.

### Example—Equity Preservation UPREIT Scenario

In one Equity Preservation UPREIT (EPU) a hotel is valued at the date of acquisition based on the projected year 3 performance. The seller's (contributor's) projections for their year 3 performance is used to apply a cap rate of 9.5%, as in this case their NOI projection of $703,000 resulted in a valuation of $7,400,000. This 9.5% cap rate is the base target typically used, though it is negotiable.

From the $7.4M value, the seller's current debt balance of $6M is backed out to result in a $1.4M in equity, which is issued to the seller in the form of Transition Units, (T-units).

As the property restabilizes and approaches the stabilized NOI target, the contributor's T-Units may begin receiving distributions. The Contribution Agreement defines and stipulates the distribution rate and NOI target tied to those T-Units.

After an example 3-year time period where the property can continue ramping up in performance, the T-Units convert to A-Units, which are essentially treated as common shares in the fund. Three years has been determined to be an adequate length of time for the contributed property's net operating income (NOI) to stabilize relative to the time of contribution. Alternative time periods may be negotiated; however, the critical factor is that a sufficient duration must elapse, where the sufficiency of time is determined by the contributor, so as to allow for potential growth in the property's net operating income (NOI), thereby enhancing the contributor's T-Unit to A-Unit conversion ratio. The conversion value in the revaluation of the property in that third year based on the then-current T12 NOI multiplied by the same 9.5% cap rate.

From the new value, items such as the original debt, funds for recapitalization and capex, and liquidity that may have been provided at closing are subtracted. The remaining equity after backing out those capital items is what will be converted into A-units in the portfolio.

For example, if a property has a trailing twelve-month (TTM) NOI of $713,000 in March 2025, applying a cap rate of 8.25% results in a valuation of approximately $8.642 million. From that valuation, various capital items are deducted, such as an outstanding loan balance of $13.845 million, loan-related fees and expenses of $402,000, operating cash infusions of $2.884 million, and a 10% minimum cumulative yield totaling $3.629 million. Other potential deductions may include funds previously allocated to PIP (property improvement plans), capex, or unreimbursed costs. After all applicable deductions, the residual value, if any, may be used to determine the number of A-units issued to the contributor upon conversion.

The benefit of this process is that it allows the purchaser to adjust the real purchase price of the property based on its actual performance following contribution. Rather than front-loading distributions into the purchase price, this model allows contributors to earn distributions annually, with payment only occurring after such earnings are realized. This deferred structure provides a more accurate valuation at the time of conversion, ensuring the purchaser neither overpays nor underpays for the property. From the contributor's perspective, it rewards superior future performance, particularly if the property significantly outperforms initial expectations, thereby ensuring fair and proportional compensation.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

1. A computer implemented method for determining a value of real estate contributed to an umbrella partnership REIT (UPREIT), a computer system executing a program of computer readable instructions for performing the method comprising the steps of:
accepting, by an operating partnership of the UPREIT, title to real estate contributed to the UPREIT such that the real estate is indirectly owned through the operating partnership;
determining, using the computer system, a number of transition units of the operating partnership based only on historical performance of the real estate;
distributing, using the computer system, the determined number of transition units in exchange for accepting title to the real estate;
calculating, using the computer system, a value of the transition units based on NOI performance of the real estate and subtracting expenses of the real estate, wherein the historical performance and the NOI performance are both measured based on net operating income of the real estate, the transition units begin receiving distributions as the real estate contributed to the UPREIT re-stabilizes and approaches a stabilized NOI target of stabilized costs once a predefined average cost is consistent; and
converting, using the computer system, the transition units to common units of the operating partnership based on the calculated value to determine a value of the real estate contributed to UPREIT wherein the converting occurs after a predetermined period during which no distributions are paid on the transition units.

2. The method as recited in claim 1, wherein the determining the number of transition units is further based on a capitalization rate.

3. The method as recited in claim 1, further comprising revaluating, using the computer system, the value of the transition units after a set period of time such that the transition units track the NOI performance of the real estate.

4. The method as recited in claim 34, wherein the set period of time is a past full calendar year, a trailing 12 months, or a past full fiscal year.

5. The method as recited in claim 1, wherein the determining the number of transition units is not based on future or projected performance of the real estate.

6. The method as recited in claim 1, wherein the distributing the determined number of transition units comprises transferring title to the transition units to a contributor of the real estate.

7. The method as recited in claim 1, wherein the calculating the value of the transition units occurs 1-5 years from a date the accepting title to the real estate occurs.

8. The method as recited in claim 1, wherein the calculating the value of the transition units occurs 6-10 years from a date the accepting title to the real estate occurs.

9. The method as recited in claim 1, wherein the calculating the value of the transition units is further based on subtracting costs incurred by the operating partnership in connection with the accepting title to the real estate.

10. The method as recited in claim 1, wherein the calculating the value of the transition units is further based on subtracting amounts incurred to assume debt.

11. The method as recited in claim 1, wherein the calculating the value of the transition units is further based on subtracting amounts incurred to defease debt.

12. The method as recited in claim 1, wherein the calculating the value of the transition units is further based on subtracting amounts incurred to originate debt.

13. The method as recited in claim 1, wherein the determining the number of transition units of the operating partnership is further based on debt which is associated with the real estate and which is assumed by the operating partnership.

14. The method as recited in claim 1, wherein the determining the number of transition units of the operating partnership is further based on debt which is associated with the real estate and which is defeased by the operating partnership.

15. The method as recited in claim 1, wherein the determining the number of transition units of the operating partnership is further based on debt which is associated with the real estate and which is originated by the operating partnership.

16. The method as recited in claim 1, further comprising converting the common units of the operating partnership to common shares of the UPREIT, using the computer system, in response to the real estate being sold by the operating partnership.

17. The method as recited in claim 1, further comprising converting the common units of the operating partnership to common shares of the UPREIT, using the computer system, in response to liquidation of the UPREIT's portfolio of property.

18. The method as recited in claim 1, wherein a Contribution Agreement defines a § 721 UPREIT transaction's terms and stipulates the distribution rates and NOI targets associated with the issued transition units.

19. A computer implemented method for determining a value of real estate contributed to an umbrella partnership REIT (UPREIT), a computer system executing a program of computer readable instructions for performing the method comprising the steps of:
accepting, by an operating partnership of the UPREIT, title to real estate contributed to the UPREIT such that the real estate is indirectly owned through the operating partnership;
determining, using the computer system, a number of transition units of the operating partnership based only on historical performance of the real estate;
distributing, using the computer system, the determined number of transition units in exchange for accepting title to the real estate;
calculating, using the computer system, a value of the transition units based on NOI performance of the real estate and subtracting expenses of the real estate, wherein the historical performance and the NOI performance are both measured based on net operating income of the real estate, the transition units begin receiving distributions as the real estate contributed to the UPREIT re-stabilizes and approaches a stabilized NOI target; and
converting, using the computer system, the transition units to common units of the operating partnership based on the calculated value to determine a value of the real estate contributed to UPREIT, wherein the converting occurs after 36 months.

20. A computer implemented method for determining a value of real estate contributed to an umbrella partnership REIT (UPREIT), a computer system executing a program of computer readable instructions for performing the method comprising the steps of:
accepting, by an operating partnership of the UPREIT, title to real estate contributed to the UPREIT such that the real estate is indirectly owned through the operating partnership;
determining, using the computer system, a number of transition units of the operating partnership based only on historical performance of the real estate;
distributing, using the computer system, the determined number of transition units in exchange for accepting title to the real estate;
calculating, using the computer system, a value of the transition units based on NOI performance of the real estate and subtracting expenses of the real estate, wherein the historical performance and the NOI performance are both measured based on net operating income of the real estate, the transition units begin receiving distributions as the real estate contributed to the UPREIT re-stabilizes and approaches a stabilized NOI target; and
converting, using the computer system, the transition units to common units of the operating partnership based on the calculated value to determine a value of the real estate contributed to UPREIT, wherein the converting occurs after an extension period of up to 12 months, during which no distributions are paid on the transition units.

21. The method as recited in claim 1, wherein the UPREIT re-stabilizes and approaches a stabilized NOI target of stabilized costs once a predefined average trash weight is consistent.

22. The method as recited in claim 1, wherein the UPREIT re-stabilizes and approaches a stabilized NOI target of stabilized costs once a predefined average water usage is consistent.

23. The method as recited in claim 1, wherein the UPREIT re-stabilizes and approaches a stabilized NOI target of stabilized costs once a predefined average sewage usage is consistent.

24. The method as recited in claim 1, wherein the contributor's transition units begin receiving distributions in response to when the property approaches the stabilized NOI target.
